(19) United States
(12) Patent Application Publication
(10) Pub. No.: US 2022/0355135 A1
(43) Pub. Date: Nov. 10, 2022

(54) TEMPORARY CABLE HORIZONTAL LIFELINE KITS, SYSTEMS AND METHODS

(71) Applicant: Alexander Andrew, Inc. DBA Falltech, Compton, CA (US)

(72) Inventor: Zachary Winters, Los Angeles, CA (US)

(21) Appl. No.: 17/315,295

(22) Filed: May 8, 2021

(51) Int. Cl. A62B 35/00; A62B 35/04

(52) U.S. Cl. CPC A62B 35/0056; A62B 35/0068; A62B 35/04; A62B 35/0081

(57) ABSTRACT

A temporary cable horizontal lifeline (HLL) kit for fall protection includes a wire cable and a ratchet tensioner with adjustable length webbing that includes a first end portion with a first carabiner and a second end portion with a second carabiner. The kit further includes a first energy absorber, a first clamp and a second clamp, a first shackle and a second shackle, and a first end anchorage connector and a second end anchorage connector.

### BACKGROUND

### Field

The embodiments relate to fall protection lifelines, and in particular to temporary cable horizontal lifeline (HLL) protection elements, adjustable accessory configurations, systems. methods and kits.

### Description of the Related Art

Workers that work in elevated environments may employ fall protection gear, such as a fall protection lifeline.

### SUMMARY

One embodiment of the invention provides a temporary cable horizontal lifeline (HLL) kit for fall protection includes a wire cable and a ratchet tensioner with adjustable length webbing that includes a first end portion with a first carabiner and a second end portion with a second carabiner. The kit further includes a first energy absorber, a first clamp and a second clamp, a first shackle and a second shackle, and a first end anchorage connector and a second end anchorage connector.

Another embodiment of the invention provides a method of forming a temporary cable HLL for fall protection including attaching a first carabiner to a first attachment opening of a first end of a first energy absorber. A second carabiner is attached to a second attachment opening of a second end of the first energy absorber and to a first end of webbing of an adjustable ratchet tensioner. A third carabiner is attached to a second end of the webbing of the adjustable ratchet tensioner and to a first terminated end of a cable. A fourth carabiner is attached to a second terminated end of the cable and a second end of webbing of the adjustable ratchet tensioner. The webbing is released from the adjustable ratchet tensioner to provide slack for the temporary cable HLL and lengthen the temporary cable HLL. The method further includes attaching the first carabiner to a first anchor connection, attaching the fourth carabiner to a second anchor connection, and adjusting tension of the cable by ratcheting the adjustable ratchet tensioner to remove the slack from the temporary cable HLL.

Still another embodiment of the invention provides a temporary cable HLL system for fall protection that includes a first connection portion of a wire cable coupled to a first end of a ratchet tensioner that includes an adjustable length webbing. A first connection portion of a first energy absorber is coupled to a second end of the ratchet tensioner. A first shackle is coupled to a second connection portion of the first energy absorber. A first end anchorage connector is coupled to a second connection portion of the wire cable. A second end anchorage connector is coupled to the first shackle.

Other aspects and advantages of the present invention will become apparent from the following detailed description, which, when taken in conjunction with the drawings, illustrate by way of example the principles of the invention.

### BRIEF DESCRIPTION OF THE DRAWINGS

The embodiments are illustrated by way of example, and not by way of limitation, in the Figures of the accompanying drawings and in which like reference numerals refer to similar elements and in which:

FIG. 1 illustrates an example of components for a temporary cable horizontal lifeline (HLL) system;

FIG. 2 illustrates an example use-case for using the components shown in FIG. 1;

FIG. 3 illustrates anchorage strength requirements for the temporary cable HLL of FIG. 2 using components from FIG. 1;

FIG. 4 illustrates an example temporary cable HLL system for a single span of up to 60 feet;

FIG. 5 illustrates an example temporary cable HLL system for a single span between 60 feet to 100 feet;

FIG. 6 illustrates adjusting of a turnbuckle for an example temporary cable HLL system;

FIG. 7 illustrates an exemplary temporary cable HLL system for fall protection including a ratchet strap tensioner, according to one embodiment of the invention;

FIG. 8 illustrates gripping of a handle and release mechanism for a ratchet strap tensioner for a temporary cable HLL system, according to one embodiment of the invention;

FIG. 9 illustrates a ratchet strap tensioner incorporated in a temporary cable HLL system, according to one embodiment of the invention;

FIG. 10 illustrates tying down of a webbing strap for a ratchet strap tensioner for a temporary cable HLL system, according to one embodiment of the invention; and

FIG. 11 illustrates a method for deploying a temporary cable HLL system for fall protection using a ratchet strap tensioner, according to one embodiment of the invention.

### DETAILED DESCRIPTION

The following description is made for the purpose of illustrating the general principles of the invention and is not meant to limit the inventive concepts claimed herein. Further, particular features described herein can be used in combination with other described features in each of the various possible combinations and permutations. Unless otherwise specifically defined herein, all terms are to be given their broadest possible interpretation including meanings implied from the specification as well as meanings understood by those skilled in the art and/or as defined in dictionaries, treatises, etc.

The description may disclose several preferred embodiments of fall protection temporary cable HLL kits and systems including protection elements and adjustable accessory configurations, as well as operation and/or component parts thereof. While the following description will be described in terms of fall protection temporary HLL kits, systems, devices/components and methods of deployment for clarity and to place the invention in context, it should be kept in mind that the teachings herein may have broad application to all types of systems, devices and applications.

One embodiment of the invention provides a temporary cable HLL kit for fall protection includes a wire cable and a ratchet tensioner with adjustable length webbing that includes a first end portion with a first carabiner and a second end portion with a second carabiner. The kit further includes a first energy absorber, a first clamp and a second clamp, a first shackle and a second shackle, and a first end anchorage connector and a second end anchorage connector.

One or more embodiments provide a temporary cable HLL that is designed as a temporary reusable anchorage subsystem for the attachment of up to two personal fall arrest systems (PFASs). One or more embodiments for temporary cable HLL kit, systems and devices when used as instructed are occupational safety and health administration (OSHA) 1910.140 and 1926.502 compliant.

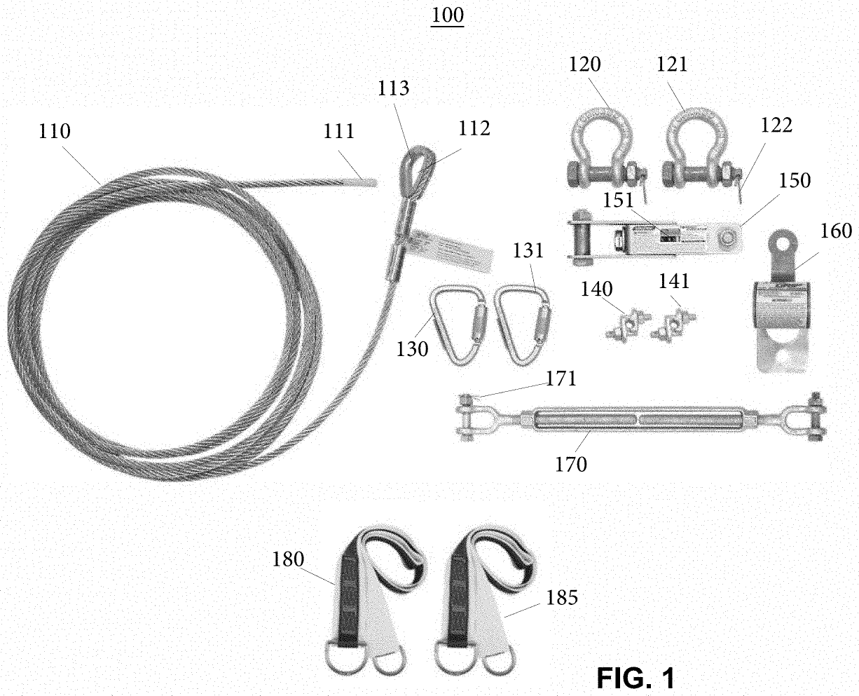

FIG. 1 illustrates an example of components for a temporary cable HLL system or kit 100. Cable HLL and stanchion systems provide temporary, portable and continuous anchoring for worksite conditions where typical anchorages along a walking surface are limited or nonexistent. The cable HLL system or kit 100 may be configured as single or multi-span systems adapting to specific anchoring needs. The temporary cable HLL system of kit 100 may be part of a personal fall arrest, restraint, work positioning, suspension, or rescue system. A PFAS is typically composed of an anchorage and a full body harness (FBH), with a connecting device, i.e., a shock absorbing lanyard (SAL), a self-retracting device (SRD), etc. attached to a dorsal D-ring of the FBH.

The temporary cable HLL system or kit 100 includes a cable (or wire rope) 110, shackles 120 and 121, carabiners 130 and 131, cable (or wire rope) clips 140 and 141, an in-line tension indicator 150 with indicator window 151, a coil energy absorber 160, a tensioning turnbuckle 170 and web pass-through sling anchors 180 and 185. In one example, the cable 110 includes a first end 112 that includes a thimble-eye termination using a thimble 113, and a second end portion 111. The cable 110 may have a ⅜ inch or more circumference, made of steel (galvanized steel, etc.) and have a minimum strength of 5,000 lbs. The cable 110 length may vary, such as 30 feet, 60 feet, 100 feet, etc.

The shackles 120 and 121 may be made of steel (galvanized steel, etc.) and have a minimum strength of 5,000 lbs. The carabiners 130 and 131 are made of steel or plated alloyed steel with a minimum strength of 5,000 lbs. and a minimum gate strength of 3,600 lbs. The cable (or wire rope) clips 140 and 141 are made of steel (galvanized steel, etc.) and have a minimum strength of 5,000 lbs. The in-line tension indicator 150 is made of steel or plated alloyed steel with a minimum strength of 5,000 lbs. The coil energy absorber 160 is made of steel (stainless, etc.) with a minimum strength of 5,000 lbs. The tensioning turnbuckle 170 may be made of steel (galvanized, etc.) and include a jaw and jaw tensioning (by rotation of ends). The web pass-through sling anchors 180 and 185 may be made of webbing, such as polyester webbing, etc., with plated alloy steel D-Rings or equivalent, having a 5,000 lbs. Min. strength and a length of 6 feet (or more).

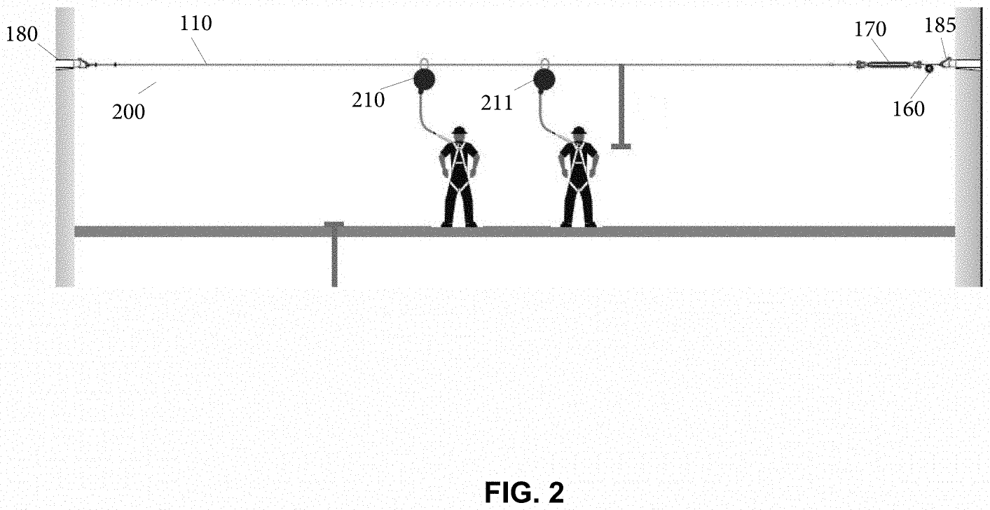

FIG. 2 illustrates an example use case for using the components shown in FIG. 1. As illustrated, when properly tensioned, the temporary cable HLL 200 (including components from the temporary cable HLL system or kit 100, FIG. 1) will react to a fall event of up to two workers by combining the energy absorbing properties of the cable 110, the coil energy absorber 160, and the worker's personal energy absorber (SRD 210, SRD 211). During a fall event, the coil energy absorber 160 deploys and elongates to absorb the energy of the fall event safely and predictably. The elongation of the coil energy absorber 160 along with the stretch of the temporary cable HLL 200 and the expansion of the user's PFAS will result in reduced forces to the anchor and to the user's body.

The temporary cable HLL 200 is a dynamic anchorage subsystem that can vary in its performance depending upon the length of the system, the number of workers attached and the type of PFAS being used. Care should be taken to understand the capacity of the system, minimum required fall clearance, anchorage strength requirements, total allowable free fall, total allowable fall clearance, and how the user's PFAS will deploy during a fall event. Longer HLL spans generate more lifeline deflection and sag during a fall event and results in greater clearance requirements.

The temporary cable HLL 200 has a maximum capacity of two workers simultaneously, with each worker weighing no more than 310 Lbs. inclusive of clothing, tools, etc. For multiple span systems, the maximum capacity is two workers per span with a maximum of six total workers per system. The temporary cable HLL 200 may be used with shock absorbing lanyards, SRDs and fall arrestor connecting subsystems. The temporary cable HLL 200 is designed to react to a fall event by elongating and deflecting to absorb energy. PFAS attached to the temporary cable HLL 200 also elongate during a fall event.

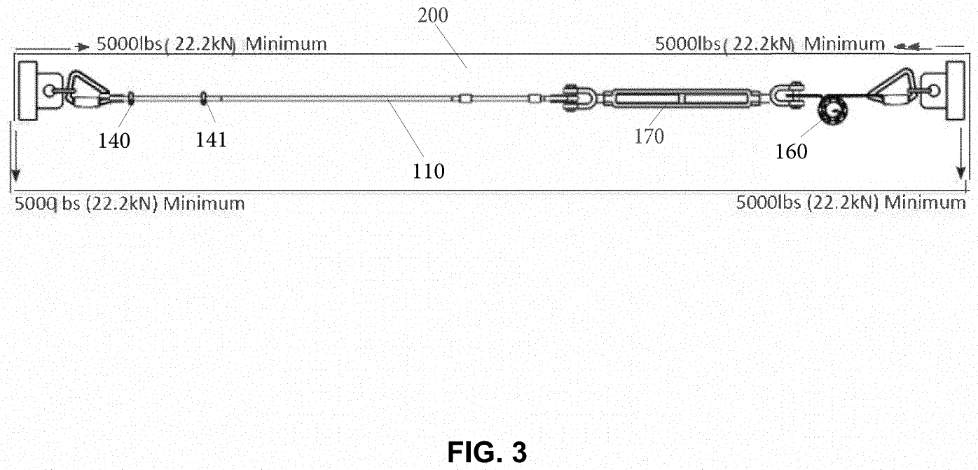

FIG. 3 illustrates anchorage strength requirements for the temporary cable HLL 200 using components from FIG. 1. The end anchors selected for use with the temporary cable HLL 200 must have a minimum rating of 5,000 lbs. (22.2 kN). The mounting points for the anchorage must be capable of supporting no less than 5000 lbs.

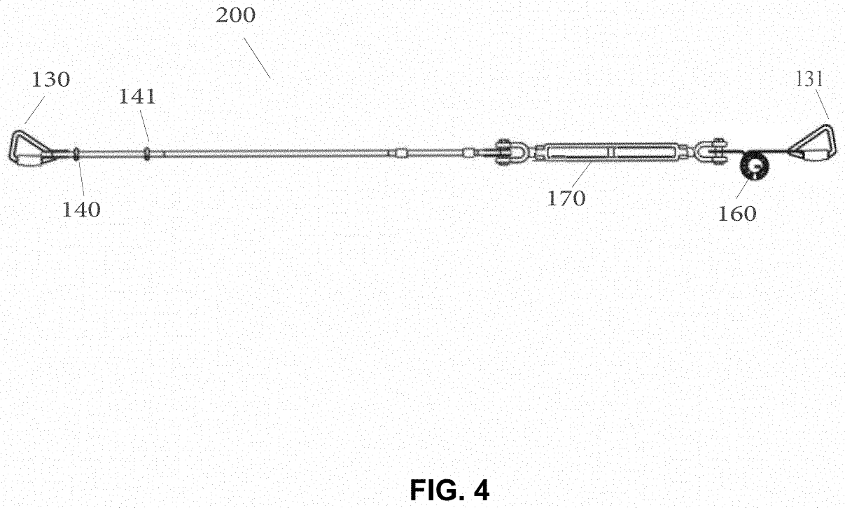

FIG. 4 illustrates an example temporary cable HLL system 200 for a single span of up to 60 feet. The anchorage selected for a PFAS must have the strength to sustain a static load applied in the direction permitted by the PFAS of at least two times the maximum arrest force permitted when certification exists, or 5,000 lbs. (22.2 kN) in the absence of certification. As shown, the single span temporary cable HLL system 200 can have lengths up to 60 feet or less, and uses a single coil energy absorber 160.

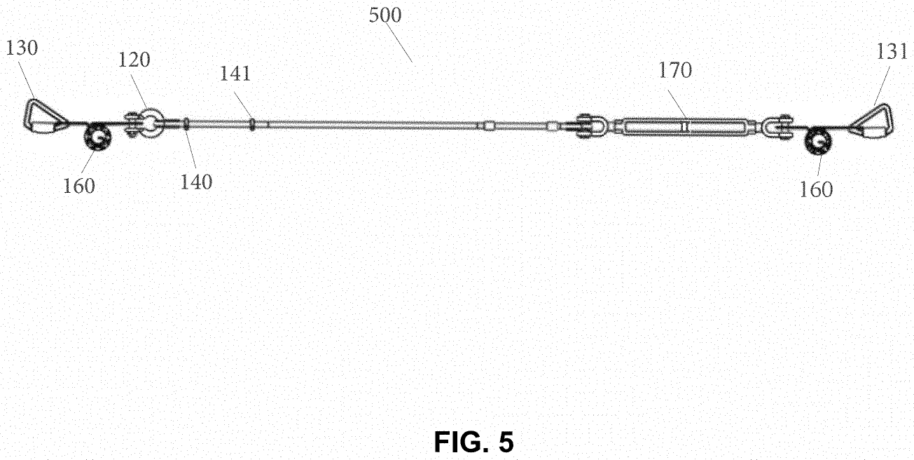

FIG. 5 illustrates an example temporary cable HLL system 500 (using components from the temporary cable HLL system or kit 100) for a single span between 60 feet to 100 feet. When a single span length is longer than 60 feet, it must use two coil energy absorbers 160 as shown for the temporary cable HLL system 500.

When deploying a temporary cable HLL system (e.g., temporary cable HLL system or kit 100, FIG. 1, temporary cable HLL 200, FIG. 2, temporary cable HLL 500, etc.), the locations of the end anchorage connectors (e.g., web pass-through sling anchors 180 and 185, stanchions, etc.) must be determined first. The anchorage selected for a PFAS must have the strength to sustain a static load applied in the direction permitted by the PFAS of at least two times the maximum arrest force permitted when certification exists, or 5,000 lbs. (22.2 kN) in the absence of certification. Next, the end anchorage connectors are used to secure the temporary cable HLL system by the carabiners 130 and 131 by attaching them to the anchorage connectors.

Holding the cable 110 side jaw of the turnbuckle 170 prevents the temporary cable HLL system from twisting, where a tool (e.g., any appropriate hand tool) is used to rotate the turnbuckle 170. The user should rotate the turnbuckle 170 such that the jaws draw toward each other. If the in-line tension indicator 150 is not being used, the turnbuckle 170 should be tightened until the center of the temporary cable HLL system sags no more than six (6) inches below the anchorage end points. If the in-line tension indicator 150 is being used, the turnbuckle 170 should be tightened until the in-line tension indicator 150 is located in a center green section of the window 151 (FIG. 1) on the front of the in-line tension indicator 150. Once properly tensioned, temporary cable HLL system may be used.

Connecting to temporary cable HLL system is accomplished by approaching the work area using the appropriate access equipment, and connecting the PFAS connector (free end connector on the SAL or SRD) directly to the cable 110. At this point, the user should not connect to any component other than the cable 110. The connectors of the temporary cable HLL system must meet all compatibility and strength requirements.

Upon completion of work, to move to a new location or to disconnect from the end anchorage connectors, the tension of the temporary cable HLL system should be released. In order to release the tension of the temporary cable HLL system, the cable side jaw of the turnbuckle 170 should be held to prevent the temporary cable HLL system from twisting, and an appropriate hand tool should be used to rotate the turnbuckle 170 as follows. The turnbuckle 170 should be rotated such that the jaws draw away from each other. Once enough tension has been removed from the temporary cable HLL system, the end attachment carabiners 130 and 131 should be removed from their anchor points. The set-up and take-down of the temporary cable HLL system using the turnbuckle 170 typically takes about twenty (20) minutes or so.

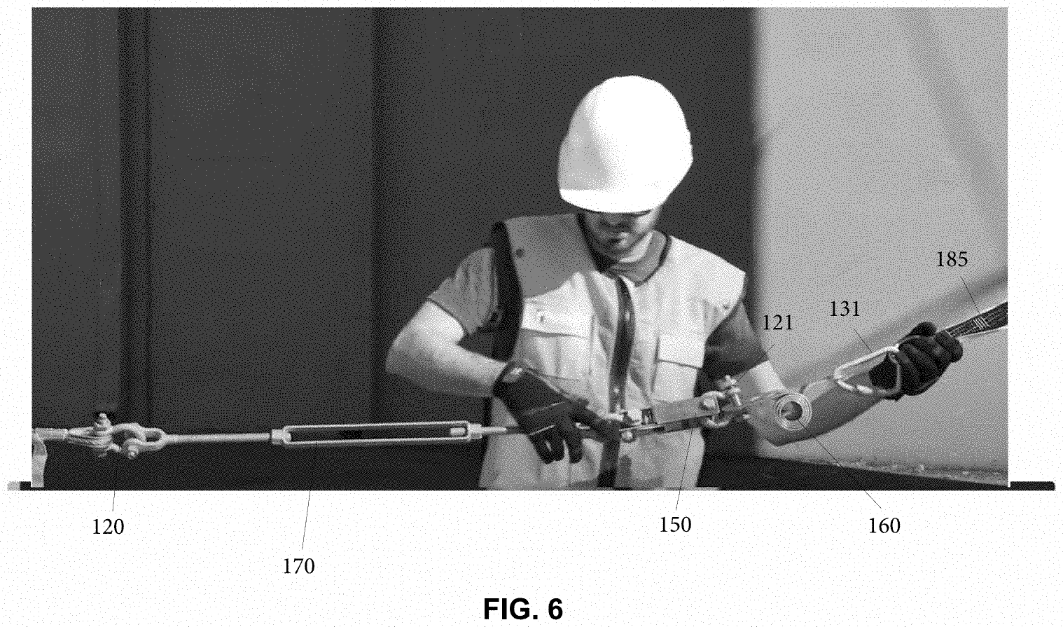

FIG. 6 illustrates adjusting of the turnbuckle 170 for an example temporary cable HLL system. Holding the cable 110 side jaw of the turnbuckle 170 prevents the temporary cable HLL system from twisting, where a tool (e.g., any appropriate hand tool) may be used to rotate the turnbuckle 170. The user should rotate the turnbuckle 170 such that the jaws draw toward each other. If the in-line tension indicator 150 is not being used, the turnbuckle 170 should be tightened until the center of the temporary cable HLL system sags no more than six (6) inches below the anchorage end points. If the in-line tension indicator 150 is being used, the turnbuckle 170 should be tightened until the in-line tension indicator 150 is located in a center green section of the window 151 (FIG. 1) on the front of the in-line tension indicator 150. Once properly tensioned, temporary cable HLL system may be used.

Connecting to temporary cable HLL system is accomplished by approaching the work area using the appropriate access equipment, and connecting the PFAS connector (free end connector on the SAL or SRD) directly to the cable 110. At this point, the user should not connect to any component other than the cable 110. The connectors of the temporary cable HLL system must meet all compatibility and strength requirements.

Upon completion of work, to move to a new location or to disconnect from the end anchorage connectors, the tension of the temporary cable HLL system should be released. In order to release the tension of the temporary cable HLL system, the cable side jaw of the turnbuckle 170 should be held to prevent the temporary cable HLL system from twisting, and an appropriate hand tool should be used to rotate the turnbuckle 170 as follows. The turnbuckle 170 should be rotated such that the jaws draw away from each other. Once enough tension has been removed from the temporary cable HLL system, the end attachment carabiners 130 and 131 should be removed from their anchor points. The set-up and take-down of the temporary cable HLL system using the turnbuckle 170 typically takes about twenty (20) minutes or so.

Upon completion of work, to move to a new location or to disconnect from the end anchorage connectors, the tension of the temporary cable HLL system should be released. In order to release the tension of the temporary cable HLL system, the cable side jaw of the turnbuckle 170 should be held to prevent the temporary cable HLL system from twisting, and an appropriate hand tool should be used to rotate the turnbuckle 170 as follows. The turnbuckle 170 should be rotated such that the jaws draw away from each other. Once enough tension has been removed from the temporary cable HLL system, the end attachment carabiners 130 and 131 should be removed from their anchor points. The set-up and take-down of the temporary cable HLL system using the turnbuckle 170 typically takes about twenty (20) minutes or so, and is typically repeated by a user eight to ten (8-10) times a day.

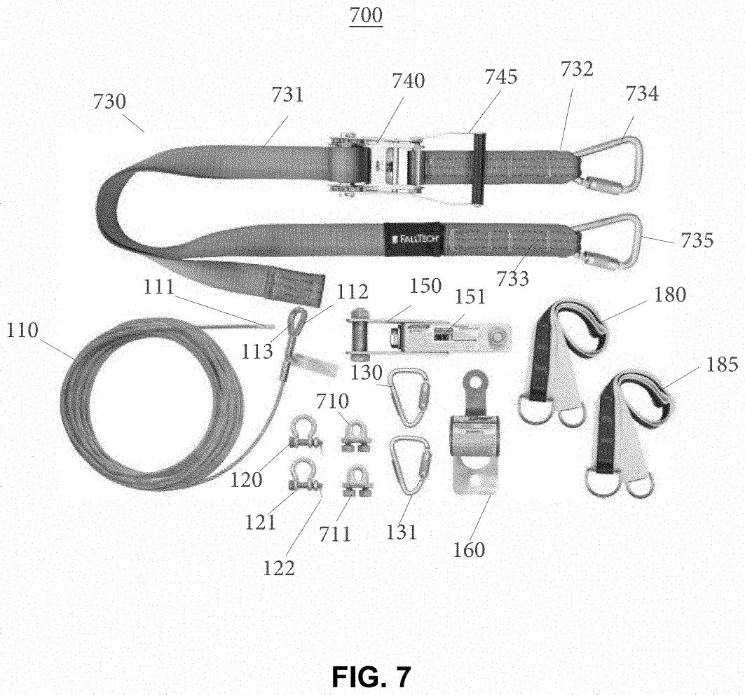

FIG. 7 illustrates an exemplary temporary cable HLL system or kit 700 for fall protection including a ratchet strap tensioner 730, according to one embodiment of the invention. As shown, the temporary cable HLL system or kit 700 is similar to that of the temporary cable HLL system or kit 100 (FIG. 1) without the cable side jaw of the turnbuckle 170, and with a ratchet strap tensioner 730 and wire rope clips (or clamps) 710 and 711, according to one embodiment.

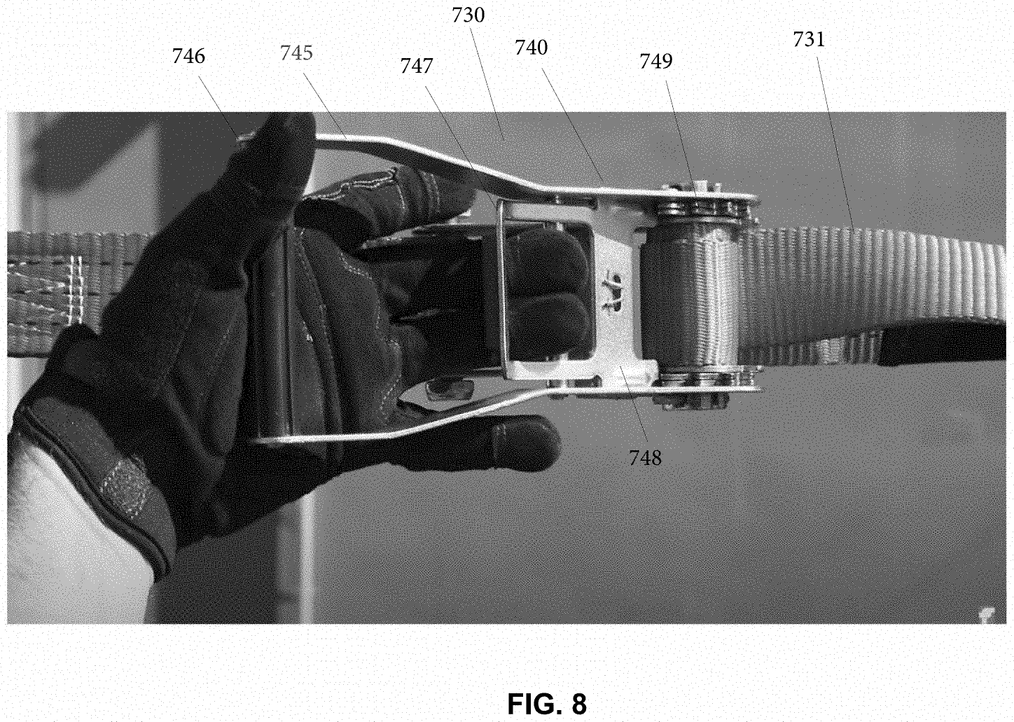

In one embodiment, the ratchet strap tensioner 730 includes (adjustable length) webbing 731, reinforced (double webbing, horizontal and vertical stitching) end portions 732 (or fixed end portion) and 733 (or adjustable end portion), carabiners 734 and 735, ratchet (or tension device including a ratchet mechanism) 740 including ratchet teeth 749 (FIG. 8) on a drive gear and release component 748 (FIG. 8) and release handle 747 (FIG. 8) and handle extension portion 745 with handle 746 (FIG. 8). In one embodiment, the ratchet strap tensioner 730 is made of steel (e.g., plated alloy steel, etc.) and the webbing 731 is made of webbing polyester or similar materials. In one embodiment, the ratchet strap tensioner 730 has a 5,000 lbs. minimum strength, and the webbing 731 has a 5,000 lbs. minimum strength. The wire rope clips (or clamps) 710 and 711 may be made of steel (e.g., galvanized steel, etc.) and have 5,000 lbs. minimum strength.

In one or more embodiments, with the ratchet strap tensioner 730 (instead of the turnbuckle 170, FIG. 1), system set up time is significantly reduced due to the quicker mechanism and longer tensioning range (i.e., the webbing 731 maximum length is longer than the fully extended and fixed length turnbuckle 170). The temporary cable HLL system or kit 700 with the ratchet strap tensioner 730 combines low fall clearance performance and durability of a steel cable HLL system with the quick and easy installation of a synthetic rope system via the ratchet strap tensioner 730. The temporary cable HLL system or kit 700 is a complete temporary cable HLL system with or without the six (6) feet web pass-through sling anchors 180 and 185.

In some embodiments, the temporary cable HLL system or kit 700 is deployed for fall protection as follows. Initially, a carabiner 130 or 131 is attached to one end of the coil energy absorber 160. For assembly with the in-line tension indicator 150, the cotter pins 122 are removed, the nuts are unthreaded, and the bolts of shackles 120 and 121 are removed. The shackles 120 and 121 are attached on either side of the in-line tension indicator 150. One shackle (either shackle 120 or 121) is aligned with the remaining hole of the coil energy absorber 160, the shackle bolts are installed, the nuts are threaded on the shackle bolts and tightened, and the cotter pins 122 are inserted into both shackles 120 and 121. In some embodiments, the coil absorber 160 may be substituted with any other type of energy absorber that provides similar protection and performance, such as webbing or shock packs, etc.

FIG. 8 illustrates gripping of a handle 746 and release handle 747 (of release component 748) for the ratchet strap tensioner 730 for a temporary cable HLL system, according to one embodiment of the invention. The ratchet strap tensioner 730 webbing 731 is released from a locked state using the release handle 747 to expand the connection points away from each other.

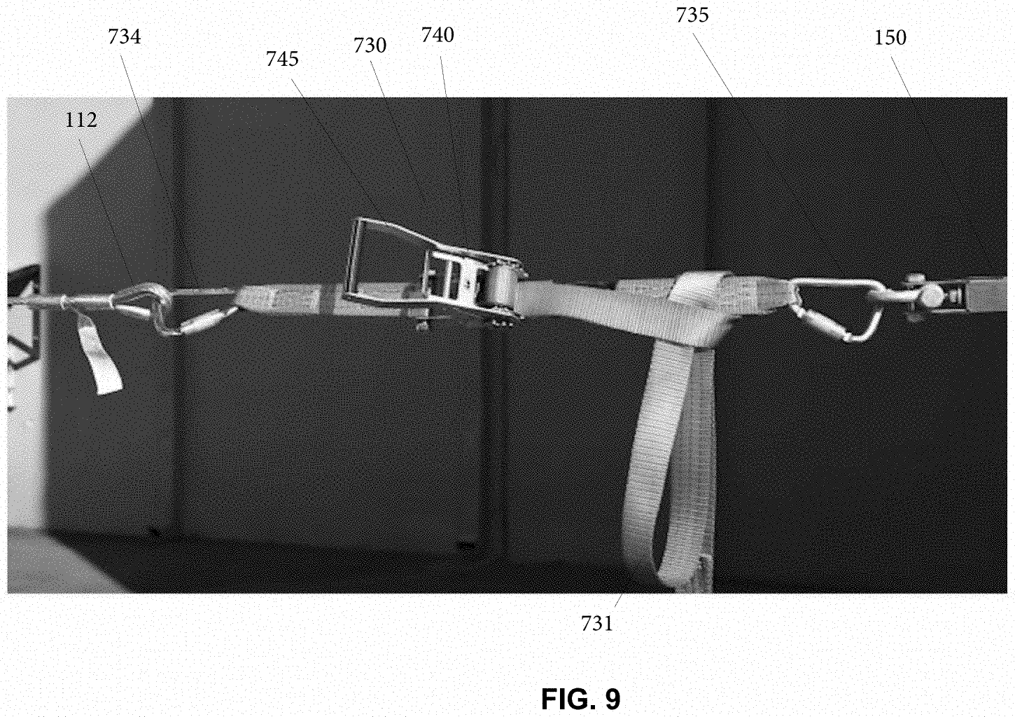

Returning to FIG. 7, the locking portion (e.g., gate lock: screw/twist-lock barrel mechanism, auto-lock mechanism, etc.) of the carabiners 734 and 735 are then removed. For assembly without the in-line tension indicator 150, connect the carabiner 735 to the open end of the coil energy absorber 160. For assembly with the in-line tension indicator 150, open one shackle 120 or 121 (removing the cotter pin 122, unscrew the nut to remove the bolt), install one shackle 120 or 121 on the bolt of the in-line tension indicator 150, and connect and lock the carabiner 735 on the shackle 120 or 121. The carabiner 734 is aligned and connected to the first end 112 that includes a thimble-eye termination with thimble 113, and the carabiner 734 is then locked (see, e.g., FIG. 9). At the appropriate length, the cable 110 is terminated (e.g., using the wire rope clips (or clamps) 710 and 711, etc.). One wire rope clip (or clamp) 710/711 is installed at the base of the thimble 113 and one wire rope clip (or clamp) 710/711 is installed at or about three (3) inches away from the other wire rope clip (or clamp) 710/711. There should be at least eight (8) inches of excess cable 110 beyond the second wire rope clip (or clamp) 710/711. The carabiner 734 is then attached to the first end 112 with thimble 113 of the cable 110. In one embodiment, if the span of the temporary cable HLL system is sixty (60) feet or less, then the temporary cable HLL system is ready to be installed.

In one embodiment, if the span of the temporary cable HLL system is greater than sixty (60) feet, then proceeds as follows. The cotter pin 122 of a shackle 120 or 121 is removed, the nut is unthreaded and the bolt is removed. The shackle 120 or 121 is inserted through the first end 112 of the cable 110. Next, the shackle 120 or 121 holes is aligned with a connection hole in a second coil energy absorber 160. The shackle 120 or 121 bolt is inserted, a nut is threaded on the bold and a cotter pin 122 is inserted. A carabiner 735 is inserted to the other end of the coil energy absorber 160.

FIG. 9 illustrates a ratchet strap tensioner 730 incorporated in a temporary cable HLL system, according to one embodiment of the invention. As shown, once the procedure for connecting the components of the temporary cable HLL system are connected together and the ratchet strap tensioner 730 is adjusted according to requirements, the loose end of the webbing 731 is tied off for an additional layer of safety and to avoid the loose webbing 731 from interfering with a user, other equipment, etc.

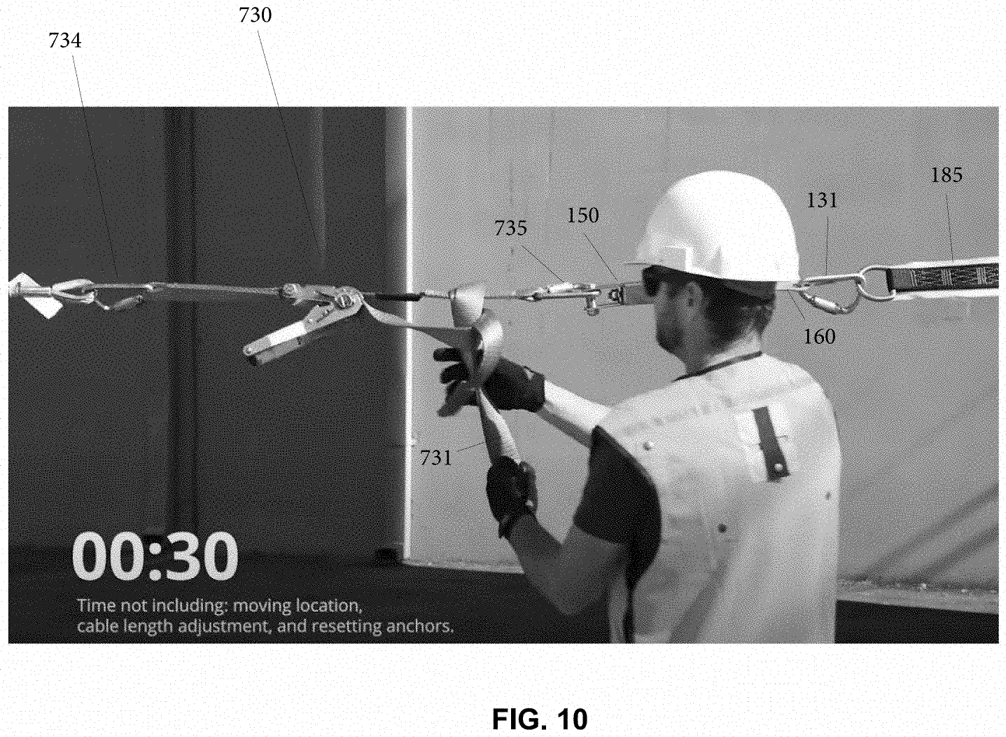

FIG. 10 illustrates tying down of a webbing strap 731 for the ratchet strap tensioner 730 for a temporary cable HLL system, according to one embodiment of the invention. The ratchet strap tensioner 730 deployment for the temporary cable HLL system reduces the tensioning time from a conventional turnbuckle 170 (see, e.g., FIGS. 1, 3-6) to about 30 seconds from about 20 minutes due at least to the attachment points, having to adjust both ends of the turnbuckle 170, and having to use a tool to adjust the turnbuckle.

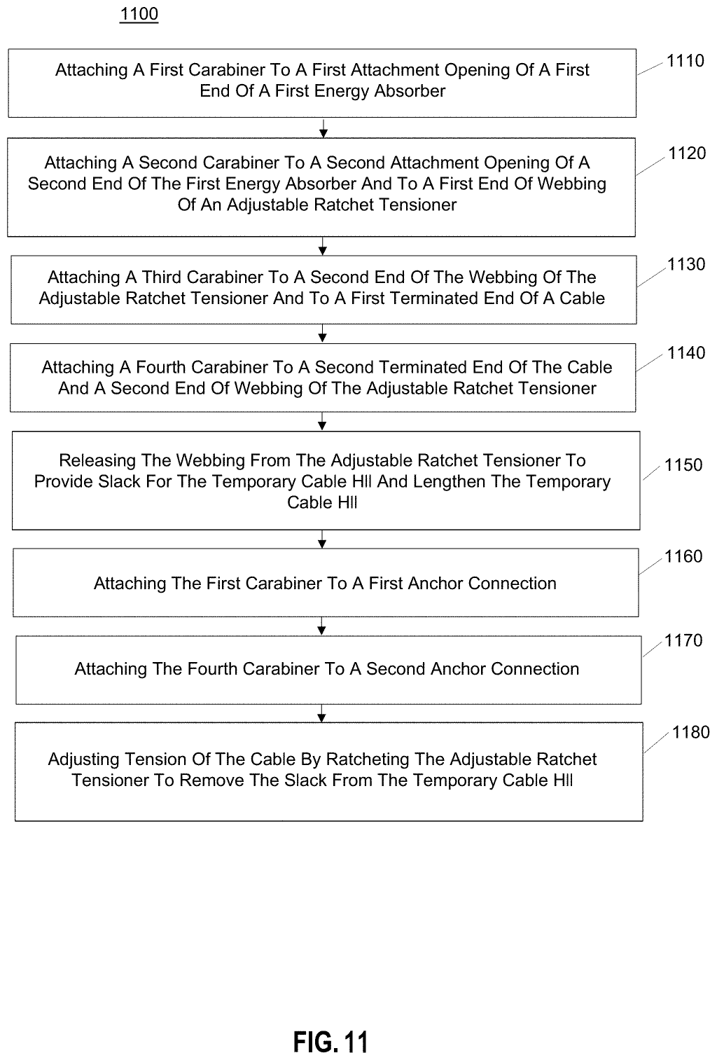

FIG. 11 illustrates a method 1100 for forming a temporary HLL system for fall protection using a ratchet strap tensioner (e.g., ratchet strap tensioner 730, FIGS. 7-10) according to one embodiment of the invention. In one embodiment, in block 1110 method 1100 includes attaching a first carabiner (e.g., carabiner 131, FIG. 7, FIG. 10) to a first attachment opening (a through-hole, connection point, a connector opening, etc.) of a first end of a first energy absorber (e.g., coil energy absorber 160, FIG. 7, FIG. 10, webbing or shock pack type of energy absorber, etc.). In block 1120, method 1100 includes attaching a second carabiner (e.g., carabiner 735, FIG. 7) to a second attachment opening of a second end of the first energy absorber and to a first end of webbing (e.g., end portion 733, FIG. 7) of an adjustable ratchet tensioner (e.g., ratchet strap tensioner 730, FIGS. 7-10). In block 1130, the method 1100 further includes attaching a third carabiner (e.g., carabiner 734, FIG. 7, FIGS. 9-10) to a second end (e.g., end portion 732, FIG. 7) of the webbing of the adjustable ratchet tensioner and to a first terminated end of a cable (e.g., first end 112 of cable 110, FIG. 7, FIG. 9). In block 1140, the method 1100 further includes attaching a fourth carabiner (e.g., carabiner 130, FIG. 7) to a second terminated end (e.g., second end portion 111, FIG. 7) of the cable and the second end of webbing of the adjustable ratchet tensioner. In block 1150, the method 1100 still further includes releasing the webbing from the adjustable ratchet tensioner (e.g., using release component 748, FIG. 8) to provide slack (from the webbing 731) for the temporary cable HLL and lengthen the temporary cable HLL. In block 1160, method 1100 includes attaching the first carabiner to a first anchor connection (e.g., a web pass-through sling anchor 180/185, a metal stanchion, etc.). In block 1160, method 1100 further includes attaching the fourth carabiner to a second anchor connection. In block 1170, method 1100 further includes adjusting tension of the cable by ratcheting the adjustable ratchet tensioner to remove the slack from the temporary cable HLL.

In one embodiment, the method 1100 may further include detaching the second carabiner from the second attachment opening of the second end of the first energy absorber, attaching a first shackle (e.g., shackle 120/121, FIG. 7) to a first connection point of an inline tension indicator (in-line tension indicator 150, FIG. 7, FIGS. 9-10) and to the second carabiner, and attaching a second shackle (e.g., shackle 120/121, FIG. 7) to a second connection point of the inline tension indicator and to the second attachment opening of the second end of the first energy absorber.

In one embodiment, the method 1100 may additionally include detaching the third carabiner from the first terminated end of the cable, attaching a third shackle (e.g., shackle 120/121, FIG. 7) to the first terminated end of the cable, attaching the third shackle to a first attachment opening of a second energy absorber (e.g., another coil energy absorber 160, FIG. 7) and attaching the third carabiner to a second attachment opening of the second energy absorber.

In one embodiment, the method 1100 may further include detaching the third carabiner from the first terminated end of the cable, attaching a third shackle (e.g., another shackle 120/121, FIG. 7) to the first terminated end of the cable, attaching the third shackle to a first attachment opening of a second energy absorber (e.g., another coil energy absorber 160, FIG. 7), and attaching the third carabiner to a second attachment opening of the second energy absorber.

In one embodiment, the method 1100 may include the feature that the first energy absorber and the second energy absorber are each a coil energy absorber. The first anchor connection and the second anchor connection may each include a web pass-through sling anchor or a metal stanchion.

In one embodiment, the method 1100 may include the feature that the adjustable ratchet tensioner has a 5,000 pound minimum strength.

In the description above, numerous specific details are set forth. However, it is understood that embodiments of the invention may be practiced without these specific details. For example, well-known equivalent components and elements may be substituted in place of those described herein, and similarly, well-known equivalent techniques may be substituted in place of the particular techniques disclosed. In other instances, well-known structures and techniques have not been shown in detail to avoid obscuring the understanding of this description.

Reference in the specification to “an embodiment,” “one embodiment,” “some embodiments,” or “other embodiments” means that a particular feature, structure, or characteristic described in connection with the embodiments is included in at least some embodiments, but not necessarily all embodiments. The various appearances of “an embodiment,” “one embodiment,” or “some embodiments” are not necessarily all referring to the same embodiments. If the specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art.

What is claimed is:

1. A temporary cable horizontal lifeline (HLL) kit for fall protection comprising:
a wire cable;
a ratchet tensioner with adjustable length webbing that includes a first end portion with a first carabiner and a second end portion with a second carabiner;
a first energy absorber;
a first clamp and a second clamp;
a first shackle and a second shackle; and
a first end anchorage connector and a second end anchorage connector.

2. The temporary cable HLL kit of claim 1, further comprising:
a third carabiner and a fourth carabiner; and
an in-line tension indicator.

3. The temporary cable HLL kit of claim 2, further comprising a second energy absorber.

4. The temporary cable HLL kit of claim 3, wherein the first energy absorber and the second energy absorber are each one of a coil energy absorber or a shock pack energy absorber.

5. The temporary cable HLL kit of claim 1, wherein the first end anchorage connector and the second end anchorage connector each comprise a web pass-through sling anchor or a metal stanchion.

6. The temporary cable HLL kit of claim 5, wherein the ratchet tensioner, the adjustable length webbing, the first clamp, the second clamp, the first shackle and the second shackle each have a 5,000 pound minimum strength.

7. The temporary cable HLL kit of claim 2, wherein the temporary cable HLL kit is configured to provide a complete temporary cable HLL system with or without the first end anchorage connector and the second end anchorage connector.

8. A method of forming a temporary cable horizontal lifeline (HLL) for fall protection comprising:
attaching a first carabiner to a first attachment opening of a first end of a first energy absorber;
attaching a second carabiner to a second attachment opening of a second end of the first energy absorber and to a first end of webbing of an adjustable ratchet tensioner;
attaching a third carabiner to a second end of the webbing of the adjustable ratchet tensioner and to a first terminated end of a cable;
attaching a fourth carabiner to a second terminated end of the cable and the second end of webbing of the adjustable ratchet tensioner;
releasing the webbing from the adjustable ratchet tensioner to provide slack for the temporary cable HLL and lengthen the temporary cable HLL;
attaching the first carabiner to a first anchor connection;
attaching the fourth carabiner to a second anchor connection; and
adjusting tension of the cable by ratcheting the adjustable ratchet tensioner to remove the slack from the temporary cable HLL.

9. The method of claim 8, further comprising:
detaching the second carabiner from the second attachment opening of the second end of the first energy absorber;
attaching a first shackle to a first connection point of an inline tension indicator and to the second carabiner; and
attaching a second shackle to a second connection point of the inline tension indicator and to the second attachment opening of the second end of the first energy absorber.

10. The method of claim 8, further comprising:
detaching the third carabiner from the first terminated end of the cable;
attaching a third shackle to the first terminated end of the cable;
attaching the third shackle to a first attachment opening of a second energy absorber; and
attaching the third carabiner to a second attachment opening of the second energy absorber.

11. The method of claim 9, further comprising:
detaching the third carabiner from the first terminated end of the cable;
attaching a third shackle to the first terminated end of the cable;
attaching the third shackle to a first attachment opening of a second energy absorber; and
attaching the third carabiner to a second attachment opening of the second energy absorber.

12. The method of claim 10, wherein the first energy absorber and the second energy absorber are each one of a coil energy absorber or a shock pack energy absorber, the first anchor connection and the second anchor connection each comprise a web pass-through sling anchor or a metal stanchion.

13. The method of claim 8, wherein the adjustable ratchet tensioner has a 5,000 pound minimum strength.

14. A temporary cable horizontal lifeline (HLL) system for fall protection comprising:
a first connection portion of a wire cable coupled to a first end of a ratchet tensioner that includes an adjustable length webbing;
a first connection portion of a first energy absorber coupled to a second end of the ratchet tensioner;
a first shackle coupled to a second connection portion of the first energy absorber;
a first end anchorage connector coupled to a second connection portion of the wire cable; and
a second end anchorage connector coupled to the first shackle.

15. The system of claim 14, further comprising:
an in-line tension indicator coupled between the second end of the ratchet tensioner and the first energy absorber.

16. The system of claim 14, further comprising:
a second energy absorber coupled between the first connection portion of the wire cable and the first end of the ratchet tensioner.

17. The system of claim 15, further comprising:
a second energy absorber coupled between the first connection portion of the wire cable and the first end of the ratchet tensioner.

18. The system of claim 16, wherein the first energy absorber and the second energy absorber are each a coil energy absorber, the first end anchorage connector and the second end anchorage connector each comprise a web pass-through sling anchor or a metal stanchion.

19. The system of claim 14, wherein the ratchet tensioner has a 5,000 pound minimum strength.

20. The system of claim 14, wherein the system is configured to provide a complete temporary cable HLL system with or without the first end anchorage connector and the second end anchorage connector.
